(19) United States
(12) Patent Application Publication
(10) Pub. No.: US 2011/0221227 A1
(43) Pub. Date: Sep. 15, 2011

(54) Truck Bed Tonneau and Method of Manufacturing a Tonneau

(76) Inventor: Kenneth W. Kayser, Flint, MI (US)

(21) Appl. No.: 12/832,661

(22) Filed: Jul. 8, 2010

Related U.S. Application Data
(63) Continuation-in-part of application No. 29/357,437, filed on Mar. 12, 2010, now Pat. No. D631422.

(51) Int. Cl. B60P 7/02

(52) U.S. Cl. 296/100.02

(57) ABSTRACT

A tonneau cover for a truck bed is provided with an inner panel and an outer panel. A plurality of five pointed star shaped indentations are formed on the inner panel. Each indentation includes ten angularly oriented sidewalls that extend from the inner panel and converge towards an upper land. Each upper land is attached to the outer panel at spaced apart intervals and provides reinforcement in ten different directional planes along the ten sidewalls.

### CROSS-REFERENCE TO RELATED APPLICATIONS

This application is a continuation-in-part of U.S. application Ser. No. 29/357,437 filed on Mar. 12, 2010, the entire disclosure of which is incorporated by reference.

### TECHNICAL FIELD

This disclosure relates to truck bed covers that are rigid and that include an outer top panel and reinforcing inner lower panel.

### BACKGROUND

Trucks, such as pick-up trucks, may have an open bed that is enclosed on the front and opposite lateral sides by walls. A tailgate is normally provided to selectively close the back end. The top of the bed area is normally open.

Tonneaus are provided to cover the top of the bed. Tonneaus may be soft, or fabric, covers that are snapped or clipped to the top edge of the front wall, the side walls and the tailgate. Rigid tonneaus are also available that span the top of the truck bed area. Rigid tonneaus may be made of fiberglass, injection molded thermoplastic, TPO, SMC, or thermal formed thermoset plastic sheets. Rigid plastic tonneaus generally include ultraviolet protection additives in at least the top panel. Generally, an outer top panel is attached to an inner lower panel that reinforces the top panel. Sufficient reinforcement must be provided to prevent vibration when the truck is moving or buckling when objects are placed on the tonneau.

Rigid tonneau panels are generally considered to be the preferred option for durability and appearance. However, the principal drawbacks are the weight of the tonneau and the manufacturing cost. The weight of the tonneau adds to the effort required to lift the tonneau and also adversely impacts fuel economy. Tonneaus made of thermal formed thermoset plastic sheets that are drawn to shape may have linear ribs formed in the inner panel. Excessive thinning may occur in the vertical walls of linear ribs that necessitate the use of selecting thicker sheets to avoid splits and insufficient reinforcement strength properties.

There is currently a need to provide a strong and light weight tonneau cover for a truck bed and a method of making the inner panel of the tonneau that requires less material and, as a result, is less expensive. There is also a need to provide a method of making a tonneau that results in substantial energy savings and reduces the energy required to heat and form the panels. In addition, there is a need to use thinner panels for the inner reinforcing panel that reduces the overall weight of the assembly and reduces vehicle fuel consumption.

### SUMMARY

A tonneau cover for a truck bed is disclosed that includes a plurality of indentations on an inner panel that converge from the inner panel toward an outer panel and that provide stable support for the outer panel.

According to one aspect of the present invention, a tonneau is provided that includes an inner panel that provides support for an outer panel that is spaced apart from the inner panel. The outer panel has an upper wall that is bounded by a front edge, a rear edge and two side edges. The inner panel has a lower wall that is provided with a plurality of indentations. Each of the indentations may be in the shape of a five pointed star. Ten sidewalls in each indentation converge toward an upper land, and the upper lands are attached to the upper wall to provide reinforcement in ten different directional planes. As an alternative, the indentations may be in the shape of a frustum of a five pointed star pyramid.

According to another aspect of the invention, a tonneau is provided that includes a lower wall of an inner panel provided with a plurality of indentations in the shape of a frustum of a regular polygonal pyramid. The regular polygon has N sides, where N is greater than four. Sidewalls extend from each of the N sides towards an upper wall and are oriented at an angle of between 30 and 60 degrees relative to the lower panel. The sidewalls converge to form an upper land that is in the shape of the polygon. The upper lands are connected to the upper wall and provide reinforcement in N different directional planes along the N sidewalls.

In yet another aspect of the invention, a tonneau includes an outer panel with an upper wall and an inner panel with a lower wall. The lower wall is provided with a plurality of indentations that are each in the shape of a frustum of a cone. A side wall of the indentation extends radially outwardly from an upper land to the inner panel. The upper lands may be connected to the outer panel so that the sidewalls provide reinforcement in all radial directions about the upper land.

These and other aspects of the invention will be better understood in view of the attached drawings and the following detailed description of the illustrated embodiments on the invention.

### BRIEF DESCRIPTION OF THE DRAWINGS

FIG. 1 is a rear perspective view of a pick-up truck having a tonneau having discrete star shaped reinforcing members that is made according to one embodiment of the present disclosure;

FIG. 2 is a bottom plan view of the inner panel of the tonneau of FIG. 1;

FIG. 3 is a cross-sectional view taken along the line 3-3 in FIG. 2;

FIG. 4 is a bottom plan view of an inner panel of an alternative embodiment of a tonneau having discrete hexagonal shaped reinforcing members;

FIG. 5 is a cross-sectional view taken along the line 5-5 in FIG. 4;

FIG. 6 is a cross-sectional view taken along the line 6-6 in FIG. 4 illustrating an alternate embodiment of the hexagonal shaped reinforcing members of FIG. 5;

FIG. 7 is a bottom plan view of an inner panel of an alternative embodiment of a tonneau having discrete circular shaped reinforcing members; and

FIG. 8 is a cross-sectional view taken along the line 8-8 in FIG. 7.

### DETAILED DESCRIPTION

Detailed embodiments of the present invention are disclosed, but it should be understood that the disclosed embodiments may be embodied in various and alternative forms. The figures are not necessarily to scale and some features may be exaggerated or minimized to show details of particular components. Specific structural and functional details disclosed by Applicant are not to be interpreted as limiting, but merely as a representative basis for teaching one skilled in the art how to practice the present disclosure.

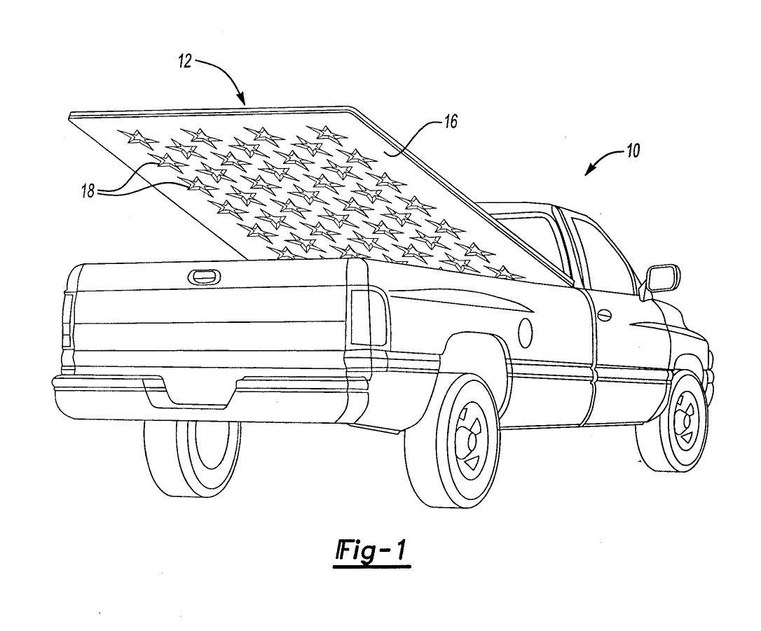

Referring to FIG. 1, a pick-up truck 10 is shown with a tonneau 12 made according to one embodiment of the disclosure. The tonneau has an outer panel 14 and an inner panel 16 that are connected together in a layered arrangement. The outer panel 14 and the inner panel 16 are formed from ABS plastic sheets in a thermal forming operation. The ABS sheets are heated and then formed against a one-sided die that draws the sheets against the die. A plurality of discrete reinforcements 18 that are in the shape of a five pointed star are formed in the inner panel 16. The reinforcements 18 are also attached to the outer panel 14 to reinforce the outer panel 14.

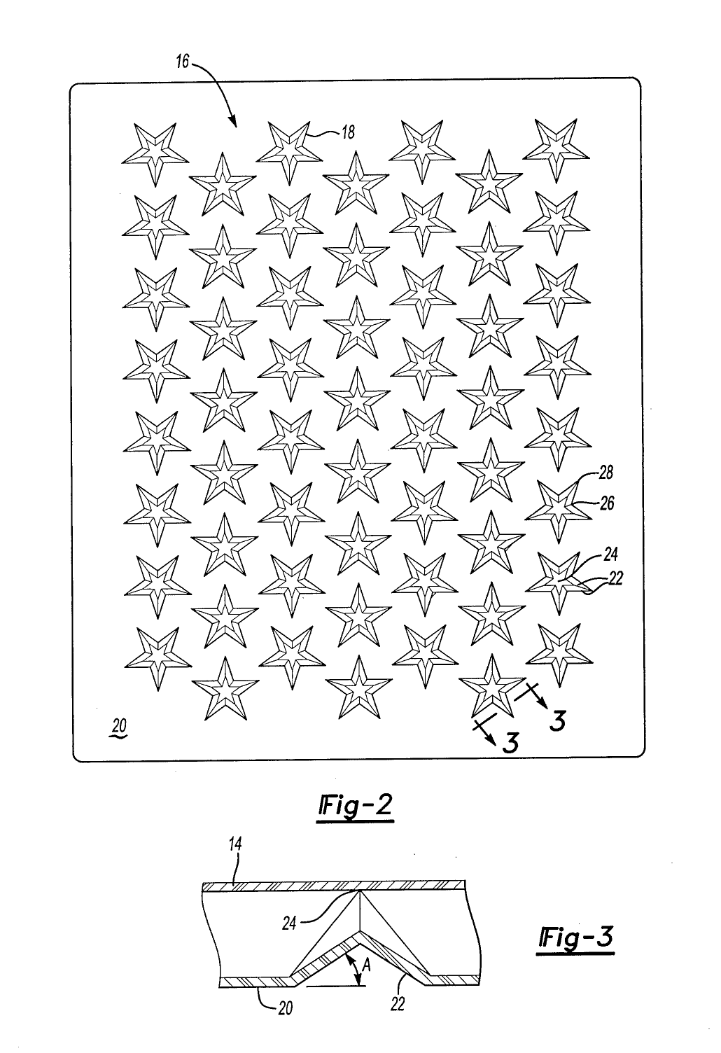

Referring to FIG. 2, the inner panel 16 is shown in greater detail. The inner panel 16 is shown from the bottom in FIG. 2. The inner panel 16 has a base wall 20 in which the reinforcements 18 are formed. The reinforcements 18 have a plurality of convergent sidewalls 22 that converge as they approach the outer panel 14. An upper land 24 is provided at the upper end of the sidewalls 22. The upper land 24 is star shaped. The reinforcement 18 in this embodiment is in the shape of a 5-point star. It should be understood that the star shape may have three or more points. Star shaped reinforcements 18 may be oriented and positioned as to be in a “clocked” arrangement so that the points of the stars are partially received within the valleys of surrounding stars. A clocked arrangement allows more reinforcements 18 to be formed on the base wall 20 to provide increased support.

FIG. 3 is a cross-section is taken along the line 3-3 in FIG. 2 that illustrates the relationship of the outer panel 14 and the inner panel 16. The upper land 24 is attached to the outer panel 14 by an adhesive, sonic welding, solvent welding, or by another plastic attachment technique. The sidewalls 22 extend upwardly from the base wall 20 (directional references as used herein are to the tonneau when installed on a pick-up truck in the closed position) and converge as they approach the outer panel 14.

In the embodiment of FIGS. 1-3, the sidewalls are oriented at about 45 degrees relative to the base wall with the angular orientation being represented by the letter “A.” The angular orientation may range from 30 to 60 degrees provided that the wall thickness is not thinned during forming and provides sufficient reinforcement. As angle A of the sidewall 22 increases above about 45 degrees the thickness of the sheet in the area of the sidewall 22 tends to thin out during forming operations, but between 30 and 60 degrees the sheet does not thin out to any substantial extent. If the sidewall is oriented at less than 30 degrees the sidewalls, less reinforcement is provided to the outer panel 14.

In the embodiment of FIGS. 1-3, while the reinforcements 18 are illustrated as a frustum of a star pyramid, it should be understood that each reinforcement 18 may be in the shape of a star that is not a frustum of a pyramid. Each star shaped reinforcement has ten sidewalls that reinforce the structure in ten different directions. Each of the sidewalls 22 is supported by adjacent sidewalls 22 that are not parallel to the upper and lower edge intersections with the outer panel 14 and inner panel 16. The upper edge intersection of the sidewall 22 with the outer panel 14 is substantially shorter than the lower edge intersection of the sidewall 22 with the inner panel 16. The intersecting sidewalls 22 and panels 14 and 16 provide a self-supporting framework that is similar to a geodesic dome. The angles connecting the wall to outer panel 14 and inner panel 16 would normally permit compression in that direction. However, other nine directions of reinforcement prevent compression of the assembly. Each reinforcement element is independent from the other reinforcements. This embodiment is of a five pointed star but it should be understood that a star having three points, four points, six points or more points can be provided that offer similar beneficial reinforcement performance.

Each reinforcement 18 has a star shaped recess in its base wall 20 and tapers to a geometrically-similar star shape on its upper land 24 The sidewalls define a frustum of a star pyramid. Forces applied to the outer panel 14 are transferred in an angular direction through the sidewalls 22 to the base wall 20. Each five pointed star has ten sidewalls 22 that extend between the outer panel 14 and the inner panel 16. Each of the ten sidewalls 22 provides a differently oriented edge that resists compression of the space between the outer panel 14 and the inner panel 16. Each of the sidewalls 22 is joined to two laterally adjacent sidewalls 22 by an inner corner 26 and an outer corner 28. The two sidewalls 22 of each point extend from a pair of inner corners 26 to an outer corner 28. The two sidewalls 22 form a V-shaped spine that is cantilevered between the outer panel 14 and the inner panel 16. The spine extends from upper land 24 to the base wall 20 between each pair of intersecting sidewalls 22 of each reinforcement 18. The intersecting sidewalls 22 and corners 26, 28 create a strong reinforcement between the outer and inner panels 14 and 16.

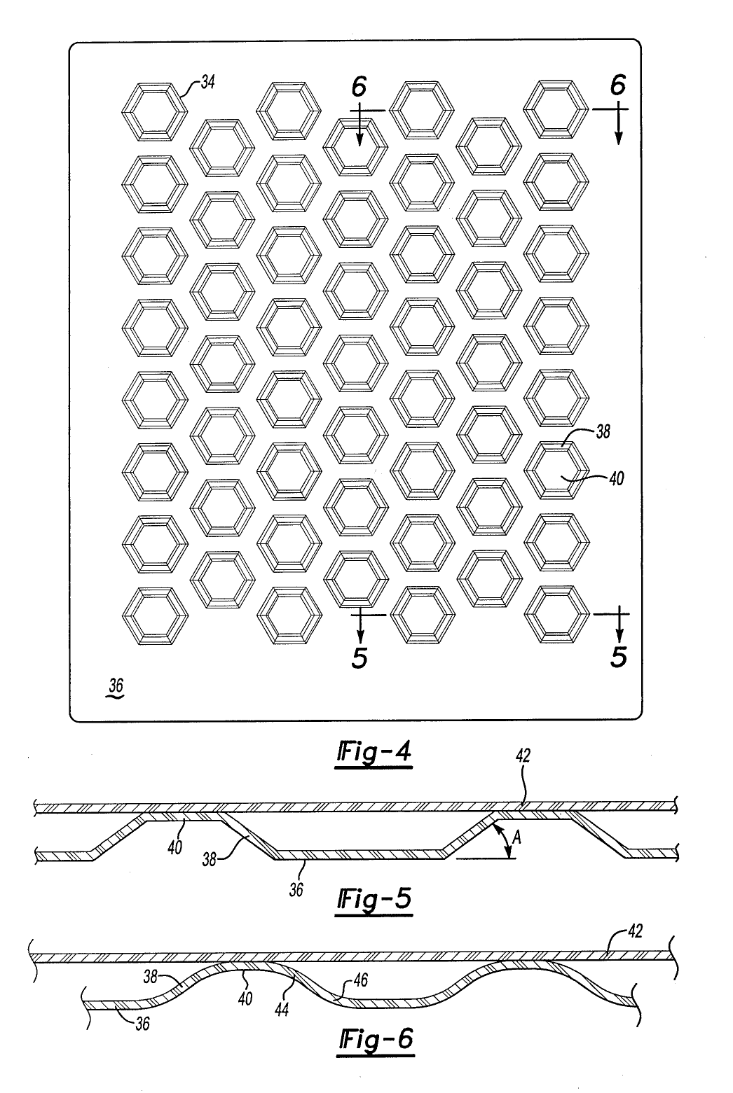

Referring to FIG. 4, another embodiment is provided in which a plurality of discrete polygonal reinforcements 34 are formed in the inner panel 16. A hexagonal reinforcement is illustrated in FIG. 4 but it should be understood that the discrete polygonal reinforcement 34 preferably has five or more sides.

Referring to FIG. 5, a cross-section is taken along the line 5-5 in FIG. 4 to show the relationship of the outer panel 42 to the inner panel 16. The sidewalls 38 extend upwardly from the base wall 36 and converge as they approach the outer panel 42. The sidewalls 38 are oriented at about 45 degrees relative to the base wall with the angular orientation being represented by the letter “A.” The angular orientation may range from 30 to 60 degrees as previously explained with reference to FIGS. 2 and 3 above.

Referring to FIG. 6, a cross-section is taken along the line 6-6 in FIG. 4 to show an alternate embodiment of the polygonal reinforcements 34. A fillet 44 connects the sidewalls 38 to the upper land 40, and a radially curved portion 46 connects the sidewalls 38 to the base wall 36. While this embodiment is illustrated with reference to a polygonal reinforcement 34, it should be understood that a fillet 44 and a radially curved portion 46 can be applied to a star shaped reinforcement 18, a frustoconical reinforcement 48, or any other shaped reinforcement.

With respect to FIGS. 4-6, each reinforcement 34 has a polygonal indentation in the base wall 36 with the convergent sidewalls 38 extending to the upper land 40 that is a geometrically-similar polygonal shape. The convergent sidewalls 38 define a frustum of a polygonal pyramid. Forces applied to the outer panel 42 are transferred in an angular direction through the sidewalls 38 to the base wall 36. The angular distribution of force through the frustum of the star pyramid in the embodiment of FIGS. 1-3 and through the frustum of the polygonal pyramid in the embodiment of FIGS. 4-6 provides a strong and durable tonneau 12. While reinforcements 34 are illustrated as a frustum of a polygonal pyramid, it should be understood that each reinforcement 34 may be in the shape of a polygon that is not a frustum of a pyramid.

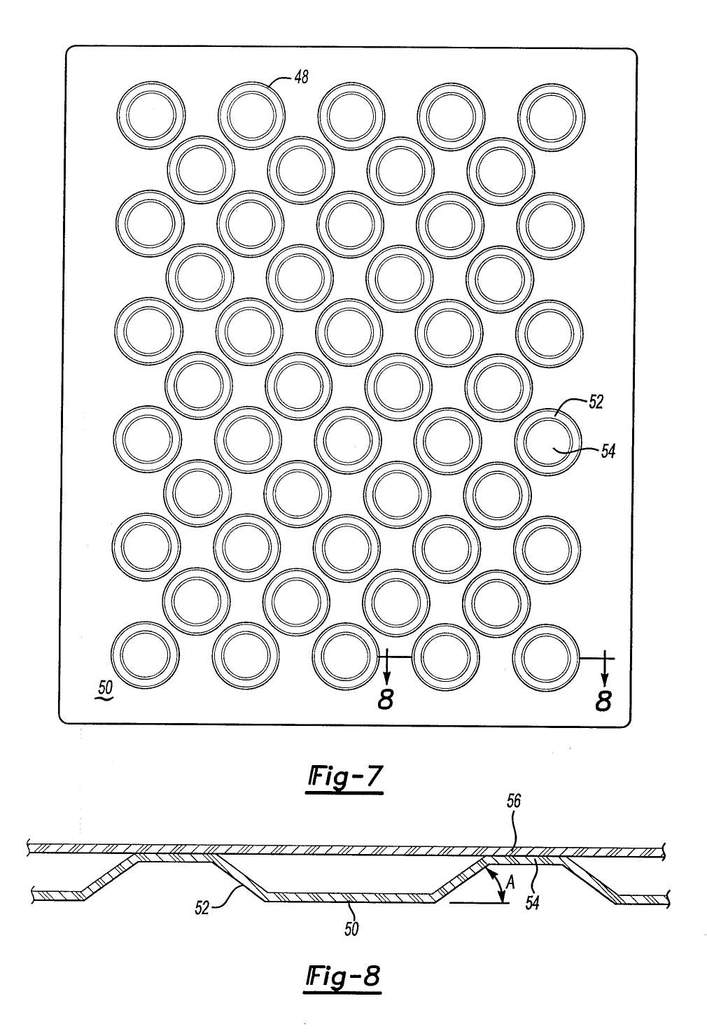

Referring to FIGS. 7 and 8, another embodiment is illustrated that includes a plurality of discrete frustoconical reinforcements 48. A circular recess is formed in the base wall 50 and a frustoconical side wall 52 (the term frustoconical as used herein refers to a frustum of a cone) extends and converges in the direction towards the outer panel 56. A circular upper land 54 is disposed at the upper end of the frustoconical sidewall 52 that is attached to the outer panel 56, as previously described with reference to the embodiments illustrated in FIGS. 1-6.

While the embodiment of FIGS. 6 and 7 does not have planar sides that extend in a plurality of lateral directions, a force applied in one direction is resisted by the balance of the perimeter of the side wall 52.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the invention.

what is claimed is:

1. A tonneau cover for a truck bed comprising:
an outer panel having an upper wall, a front edge, a rear edge and two side edges, wherein the upper wall is bounded by the front, rear and side edges;
an inner panel having a lower wall that is spaced from the upper wall and joined to the outer panel at the front, rear, and side edges, the lower wall being provided with a plurality of indentations that are in the shape of a star without a frustum of a pyramid, the indentations each have sidewalls that converge toward an upper land, and wherein the upper lands are each attached to the upper wall at spaced intervals.

2. The tonneau cover of claim 1 wherein the indentations are each in the shape of a five pointed star that each have an upper portion that is star shaped and ten angularly oriented sidewalls that extend from the upper portion to the lower wall that provide reinforcement in ten different directional planes.

3. The tonneau cover of claim 2 wherein the two sidewalls of each point of the star shape extend from a pair of inner corners to an outer corner form a V shape that are cantilevered between the upper panel and the inner panel.

4. The tonneau cover of claim 1 wherein the indentations each have a fillet connecting the sidewalls to the upper land, and wherein the indentations each have a radially curved portion connecting the sidewalls to the lower wall.

5. A tonneau cover for a truck bed comprising:
an outer panel having an upper wall, a front edge, a rear edge and two side edges, wherein the upper wall is bounded by the front, rear and side edges;
an inner panel having a lower wall that is spaced from the upper wall and joined to the outer panel at the front, rear, and side edges, the lower wall being provided with a plurality of indentations that are in the shape of a frustum of a star pyramid and are separate from each other, the indentations each have sidewalls that converge toward an upper land, and wherein the upper lands are each attached to the upper wall at spaced intervals.

6. The tonneau cover of claim 5 wherein the indentations are each in the shape of a five pointed star that each have an upper portion that is star shaped and ten angularly oriented sidewalls that extend from the upper portion to the lower wall that provide reinforcement in ten different directional planes.

7. The tonneau cover of claim 5 wherein the two sidewalls of each point of the star shape extend from a pair of inner corners to an outer corner form a V shape that are cantilevered between the upper panel and the inner panel.

8. The tonneau cover of claim 5 wherein the indentations each have a fillet connecting the sidewalls to the upper land, and wherein the indentations each have a radially curved portion connecting the sidewalls to the lower wall.

9. A tonneau cover for a truck bed comprising:
an outer panel having an upper wall, a front edge, a rear edge and two side edges, wherein the upper wall is bounded by the front, rear and side edges;
an inner panel having a lower wall that is spaced from the upper wall and joined to the outer panel at the front, rear, and side edges, the lower wall being provided with a plurality of indentations that are in the shape of a frustum of a regular polygonal pyramid and are separate from each other, the indentations each have sidewalls that converge toward an upper land, and wherein the upper lands are each attached to the upper wall at spaced intervals.

10. The tonneau cover of claim 9 wherein the indentations are each in the shape of a polygon having N sides wherein the N sides are more than four sides and that each have an upper portion that is in the shape of the polygon and that has N angularly oriented sidewalls that extend from the upper portion to the lower wall that provide reinforcement in N different directions.

11. The tonneau cover of claim 9 wherein the number of sides of the polygon N equals six.

12. The tonneau cover of claim 11 wherein the sidewalls are oriented at an angle of between 30 and 60 degrees relative to the lower panel.

13. The tonneau cover of claim 11 wherein the sidewalls are oriented at an angle of 45 degrees relative to the lower panel.

14. The tonneau cover of claim 9 wherein the indentations each have a fillet connecting the sidewalls to the upper land, and wherein the indentations each have a radially curved portion connecting the sidewalls to the lower wall.

15. A tonneau cover for a truck bed comprising:
an outer panel having an upper wall, a front edge, a rear edge and two side edges, wherein the upper wall is bounded by the front, rear and side edges;
an inner panel having a lower wall that is spaced from the upper wall, the lower wall being provided with a plurality of circular indentations that are separate from each other, the indentations each have a sidewall that extends radially outwardly from an upper land to the inner panel, wherein the upper lands are each attached to the upper wall at spaced intervals, and wherein each sidewall provides reinforcement in all radial directions about the upper land.

16. The tonneau cover of claim 15 wherein the wherein the indentations are in the shape of a frustum of a cone.

17. The tonneau cover of claim 15 wherein the indentations each have a fillet connecting the sidewalls to the upper land, and wherein the indentations each have a radially curved portion connecting the sidewalls to the lower wall.
